(19) United States
(12) Patent Application Publication
(10) Pub. No.: US 2011/0318036 A1
(43) Pub. Date: Dec. 29, 2011

(54) IMAGE FORMING APPARATUS

(75) Inventors: Keisuke Abe, Kawasaki-shi (JP); Kazuhisa Kemmochi, Suntou-gun (JP); Tsutomu Miki, Komae-shi (JP); Hikaru Osada, Kamakura-shi (JP); Takahiro Hosokawa, Kawasaki-shi (JP)

(73) Assignee: CANON KABUSHIKI KAISHA, Tokyo (JP)

(21) Appl. No.: 13/170,655

(22) Filed: Jun. 28, 2011

(30) Foreign Application Priority Data
Jun. 29, 2010 (JP) 2010-147531

(51) Int. Cl. G03G 15/20

(52) U.S. Cl. 399/67; 399/68; 399/69

(57) ABSTRACT

An image forming apparatus includes an image forming station for forming a toner image on a recording material; and a fixing portion including a heating rotatable member, a heating element for heating the heating rotatable member using heat generation by electric power supply, a pressing rotatable member for contacting the heating rotatable member to form a nip for nipping and feeding the recording material, a pressure changing member for changing a pressure to the nip, wherein the fixing portion fixes the toner image on the recording material while nipping and feeding the recording material carrying the toner image by the nip, and fixing portion is capable of changing a glossiness of the toner image by changing the pressure to the nip by operation of the pressure changing member, wherein the image forming apparatus is operable in a glossy mode in which the glossiness of the toner image is switchable, wherein a MD-1 hardness of a surface layer of the heating rotatable member contactable with the toner image is 20-70, and when the glossy mode is selected so as to raise the glossiness at the time of heating and fixing of the toner image, the pressure changing member operates so as to lower the pressure to the nip.

### FIELD OF THE INVENTION AND RELATED ART

The present invention relates to an image forming apparatus such as an electrophotographic copy machine, an electrophotographic printer, and the like.

One of the fixing apparatuses (fixing devices) which have been known to be mounted in an electrophotographic image forming apparatus, such as an electrophotographic printer, an electrophotographic copy machine, etc., is a fixing apparatus which employs a heat roller. A fixing apparatus of this type has: a fixation roller; a heater placed inside the fixation roller to heat the fixation roller; a pressure roller which is placed in contact with the fixation roller to form a nip; etc. As for the operation of a fixing apparatus of this type, while a sheet of recording medium, on which an unfixed toner image is present, is conveyed through the nip of the nip while remaining pinched between the fixation roller and pressure roller, the sheet of recording medium and the toner image thereon are heated and compressed, whereby the unfixed toner image is thermally fixed to the sheet of recording medium.

The primary function of a fixing apparatus is to reliably fix an unfixed toner image to a sheet of recording medium on which the unfixed toner image is present. However, a fixing apparatus has also a function of controlling an image forming apparatus in terms of image properties, more specifically, the image glossiness, that is, the level of glossiness at which the image forming apparatus outputs images. There are various factors which affect a fixing apparatus in terms of the level of quality at which images are outputted from an image forming apparatus. Some of these factors are: the temperature level at which the toner image on a sheet of recording medium is heated; amount of pressure applied to the toner image on the sheet of recording medium; and length of time the toner image on the recording medium is heated. Thus, a fixing apparatus is devised to be controlled in terms of these parameters so that the settings of the fixing apparatus match the properties of the toner to be used for image formation, in order to enable the image forming apparatus to output images which are desirable in glossiness.

The glossiness level at which an image is outputted by an image forming apparatus (fixing device) is affected by the type of the recording medium used for image formation, and/or user's taste. Thus, in the field of an image forming apparatus, it has been proposed to design a fixing apparatus which can be adjusted in the glossiness level at which it outputs images, in order to allow the user to obtain images, the glossiness of which is at the level desired by the user. Therefore, it has been proposed to design an image forming apparatus (fixing apparatus) so that an operator can control the image forming apparatus (fixing apparatus) in terms of the glossiness level at which the apparatus outputs an image. For example, there has been proposed in Japanese Laid-open Patent Application 2002-40863, a fixing apparatus which can be reversibly changed by a user in the amount by which it applies pressure to the toner image on a sheet of recording medium, so that the user can reversibly control the fixing apparatus in the glossiness level at which the fixing apparatus output a fixed toner image. More specifically, if it is necessary to output a glossier toner image than a normal toner image, the fixing apparatus is increased in the amount by which it applies pressure to an unfixed toner image, whereas if it is necessary to output a toner image which are less glossy than a normal toner image, the fixing apparatus is decreased in the amount by which it applies pressure to an unfixed toner image. As the other factors which affect the glossiness level at which a fixing apparatus outputs a toner image are the properties of the fixation roller which comes directly in contact with the unfixed toner image on a sheet of recording medium, more specifically, the material and laminar structure of the fixation roller, in particular, the hardness of the surface layer of a fixation roller. The hardness of the surface layer of a fixation roller affects, in combination with the pressure applied to the fixation roller by the pressure roller, the easiness with which an unfixed toner image is made to conform to the minute peaks and valleys of the surface of a sheet of recording medium. Thus, the change in the hardness of the surface layer of a fixation roller affects a fixing apparatus in the glossiness level at which it outputs a fixed toner image, and the level of uniformity at which it outputs an image at a preset glossiness level. Japanese Laid-open Patent Application 2006-39113 proposes a proper relationship among the hardness of the elastic layer of a fixation roller, hardness of the surface layer of the fixation roller, and the amount of pressure applied for fixation, which is necessary to obtain a print (copy) which is desirable in glossiness and character reproduction. In the case of the fixing apparatus disclosed in this patent application, a roller, the elastic layer and surface layer of which are made of silicone rubber and fluorinated resin, respectively, is used as the fixation roller.

Normally, a fixation roller is provided with a surface layer as a parting layer which facilitates the separation of a sheet of recording medium from the fixation roller. One of the substances used as the material for the surface layer (parting layer) of a fixation roller is fluorinated resin. However, fluorinated resin is harder than the rubbery substance used as the material for the elastic layer of a fixation roller. Thus, a fixation roller, the surface layer of which is formed of fluorinated resin is less likely to faithfully conform to the irregularities (minute peaks and valleys) of the surface of a sheet of recording medium, in particular, the surface of a sheet of recording medium made of coarse fibers or the like. Thus, the employment of a fixation roller, the surface layer of which is formed of fluorinated resin, is likely to yield a print (copy) which suffers from the irregularity in terms of glossiness, which is attributable to the nonuniformity in heating and compression, which is attributable to the microscopic peaks and valleys of the surface of a sheet of recording medium. More specifically, in a case where a fixing apparatus is changed in the fixation pressure, that is, the amount of pressure applied to a sheet of recording medium and the toner image thereon, in order to change the fixing apparatus in the image glossiness, the following problems occur. That is, increasing a fixing apparatus in the amount of the fixation nip pressure increases the fixing apparatus in the glossiness level at which it outputs an image, but, it causes the apparatus to yield an image which is less uniform in glossiness, which is attributable to the problem that because the surface of a sheet of recording medium has minutes peaks and valleys, being therefore nonuniform in texture, it exacerbate the problem that a fixing device fails to apply heat and pressure uniformly across the surface of the sheet of recording medium. On the other hand, the employment, by a fixing device, of a fixation roller, the surface layer of which is lower in hardness, being therefore is likely to conform to the minutes peaks and valleys of the surface of a sheet of recording medium, lowers the fixing apparatus in the glossiness level at which it outputs an image, even though it lowers the fixing apparatus in the level of irregularity in glossiness at which it outputs an image. This problem is attributable to the fact that because the surface layer of a fixation roller is low enough for the fixation roller to faithfully conform to the minute peaks and valleys of the surface of a sheet of recording medium, the resultant fixed toner image reflects the texture of the surface of the sheet of recording medium, being therefore nonuniform in glossiness.

### SUMMARY OF THE INVENTION

Thus, the primary object of the present invention is to provide an image forming apparatus which can be switched in image glossiness between the normal mode and high gloss mode, and yet, is lower in the level of irregularities in glossiness at which it outputs a toner image than any of image forming apparatuses in accordance with the prior art.

According to an aspect of the present invention, there is provided an image forming apparatus comprising an image forming station for forming a toner image on a recording material; and a fixing portion including a heating rotatable member, a heating element for heating said heating rotatable member using heat generation by electric power supply, a pressing rotatable member for contacting said heating rotatable member to form a nip for nipping and feeding the recording material, a pressure changing member for changing a pressure to the nip, wherein said fixing portion fixes the toner image on the recording material while nipping and feeding the recording material carrying the toner image by the nip, and fixing portion is capable of changing a glossiness of the toner image by changing the pressure to the nip by operation of said pressure changing member, wherein said image forming apparatus is operable in a glossy mode in which the glossiness of the toner image is switchable, wherein a MD-1 hardness of a surface layer of said heating rotatable member contactable with the toner image is 20-70, and when the glossy mode is selected so as to raise the glossiness at the time of heating and fixing of the toner image, said pressure changing member operates so as to lower the pressure to the nip.

According to the present invention, it is possible to provide an image forming apparatus which can be switched in image glossiness between the normal mode and high gloss mode, and yet, is lower in the level of irregularities in glossiness at which it outputs a toner image than any of image forming apparatuses in accordance with the prior art.

These and other objects, features, and advantages of the present invention will become more apparent upon consideration of the following description of the preferred embodiments of the present invention, taken in conjunction with the accompanying drawings.

### BRIEF DESCRIPTION OF THE DRAWINGS

FIG. 1(A) is a drawing for describing the process through which an unfixed toner image is thermally fixed by the fixing device of the image forming apparatus in the first preferred embodiment of the present invention, and FIG. 1(B) is a drawing for describing the process through which an unfixed toner image is thermally fixed by the fixing device of an image forming apparatus in accordance with the prior art.

FIG. 2 is illustrations which show how an unfixed toner image is thermally fixed by the fixing device of an example of a comparative image forming apparatus.

FIG. 3 is a chart which shows the compressional pressure profile and temperature profile of the fixation nip when an unfixed toner image is thermally fixed by the fixing device of the image forming apparatus in the second preferred embodiment, in the normal and high gloss modes, respectively.

FIG. 4 is charts which show the compressional pressure profile and temperature profile of the fixation nip when an unfixed toner image is thermally fixed by the fixing device of the image forming apparatus in the third preferred embodiment, in the normal and high gloss modes, respectively.

FIG. 5(a) is a flowchart of the operational sequence carried out by the control of the image forming apparatus in the first preferred embodiment to change the apparatus in operational mode when the glossiness mode is selected. FIG. 5(b) is a flowchart of thee operational sequence carried out by the control of the image forming apparatus in the second preferred embodiment to change the apparatus in operational mode when the glossiness mode is selected. FIG. 5(c) is a flowchart of the operational sequence carried out by the control of the image forming apparatus in the third preferred embodiment to change the apparatus in operational mode when the glossiness mode is selected.

FIGS. 6(a) and 6(b) are schematic sectional views of the surface layer (lower in hardness) of the fixation roller of the fixing device of the image forming apparatus in the first preferred embodiment of the present invention, when the hardness of the surface layer was measured.

FIG. 7 is a schematic vertical sectional view of the fixing device of the image forming apparatus in the first preferred embodiment of the present invention, and shows the general structure of the device.

FIG. 8 is a schematic vertical sectional view of the image forming apparatus in the first preferred embodiment of the present invention, and shows the general structure of the apparatus.

### DESCRIPTION OF THE PREFERRED EMBODIMENTS

### Embodiment 1

### (Image Forming Apparatus)

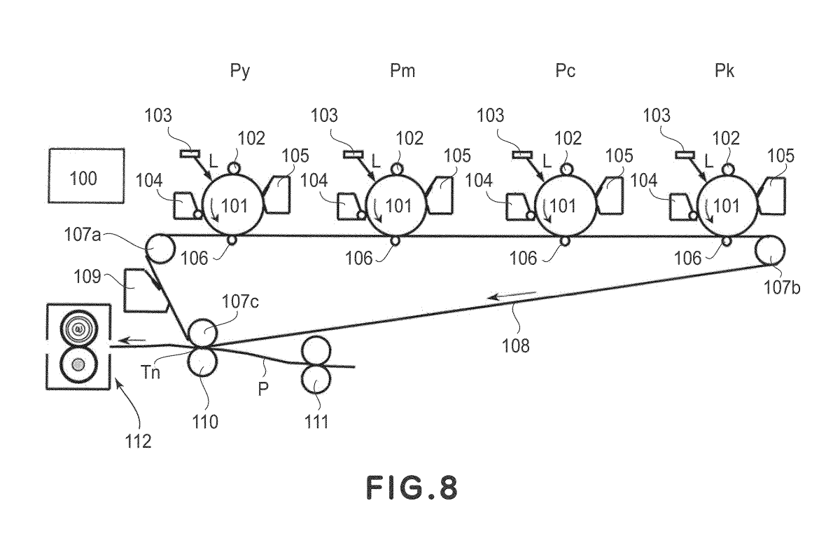

FIG. 8 is a schematic vertical sectional view of the image forming apparatus in the first preferred embodiment of the present invention, and shows the general structure of the apparatus. This image forming apparatus is a color laser beam printer, which uses an electrophotographic image formation process. It is of the so-called transfer type. It has: four image forming stations Py, Pm, Pc, and Pk; a fixing device 112 (fixing station); etc. As it receives a print start command outputted from an external apparatus (unshown) such as a host computer, its control 100, which is made up of a CPU, ROMs, memories, etc., carries out a preset image formation sequence in response to the print start command. That is, the four image forming stations Py, Pm, Pc, and Pk, which are for forming four monochromatic toner images, different in color, on a sheet of recording medium through each of the charging, exposing, developing, and transferring processes, begin to be sequentially driven, and the photosensitive drums 101 (image bearing members) are rotated in the direction indicated by an arrow mark at a preset peripheral velocity (process speed). The image forming apparatus is provided with an intermediary transfer belt 108, which is suspended and kept stretched by a belt driving roller 107a, a follower roller 107b, and transfer rollers 107c, in such a manner that the belt 108 remains in contact with each of the four photosensitive drums 101 of the image forming stations Py, Pm, Pc, and Pk, one for one. The intermediary transfer belt 108 is circularly driven by the belt driving roller 107a at a preset peripheral velocity in the direction indicated by an arrow mark. The peripheral velocity at which the intermediary transfer belt 108 is driven corresponds to the peripheral velocity at which each photosensitive drum 101 is rotated.

The image formation sequence of the image forming apparatus in this embodiment is as follows: First, the peripheral surface of the photosensitive drum 101 in the image forming station Py, that is, the image forming station for forming a monochromatic image of yellow color, or the first color, is uniformly charged to a preset polarity and a potential level by a charge roller 102. Then, the uniformly charged portion of the peripheral surface of the photosensitive drum 101 is scanned (exposed) with a beam L of laser light projected by a laser-based exposing device while being modulated according to the information regarding the image to be formed. As a given point of the uniformly charged portion of the peripheral surface of the photosensitive drum 101 is exposed, electric charge is removed from this point. As a result, an electrostatic latent image, which reflects the information regarding the image to be formed, is formed across the uniformly charged portion of the peripheral surface of the photosensitive drum 101. This electrostatic latent image is developed by a developing device 104, which has a toner container (unshown), and a development roller. The developing device 104 develops the electrostatic latent image into a visible image, that is, an image formed of toner (which hereafter will be referred to as toner image), by adhering toner to the electrostatic latent image on the photosensitive drum 101 by the application of a development bias to the development roller. Then, the toner image is transferred (first transfer) onto the intermediary transfer belt 108 by the application of a first transfer bias to a first transfer roller 106. This sequence described above is carried out also in each of the image forming stations Pm, Pc, and Pk. Consequently, four monochromatic toner images, different in color, are layered in vertical alignment on the outward surface of the intermediary transfer belt 108.

Meanwhile, a sheet P of recording medium is fed into the main assembly of the image forming apparatus from a sheet feeder cassette (unshown) in the image forming apparatus, with a preset timing, and conveyed to a transfer nip Tn, which a transfer roller 110 forms between the photosensitive drum 101 and intermediary transfer belt 108. To the transfer roller 110, a preset transfer bias is applied, whereby the layered four monochromatic toner images, different in color, on the intermediary transfer belt 108 are transferred together (second transfer) onto the sheet P of recording medium.

After the sheet P of recording medium on which a full-color toner image made up of the four monochromatic toner images, different in color, is present is conveyed out of the transfer nip Tn, it is introduced into a fixing device 112 (fixing station), which applies heat and pressure to the sheet P of recording medium and the unfixed full-color toner image thereon, to thermally fix the unfixed toner image to the sheet P of recording medium. After the fixation of the toner image to the sheet P of recording medium, the sheet P is discharged into a delivery tray (unshown).

The transfer residual toner on the peripheral surface of the photosensitive drum 101, that is, the toner remaining on the peripheral surface of the photosensitive drum 101 after the toner image transfer from the peripheral surface of the photosensitive drum 101, is removed by a cleaning device 105 to prepare the photosensitive drum 101 for the next image formation. The transfer residual toner on the surface of the intermediary transfer 105, that is, the toner remaining on the surface of the intermediary transfer 105 after the toner image transfer from the intermediary transfer 105, is removed by a cleaning device 109 to prepare the intermediary transfer belt 108 for the next image formation.

### (Fixing Device (Fixing Station))

In the following description of the fixing device, the widthwise and lengthwise directions of the fixing device and the structural components of the fixing device are the directions perpendicular and parallel, respectively, to the recording medium conveyance direction. The width of a given component is the dimension of the given component in terms of the widthwise direction. FIG. 7 is a schematic sectional view of the fixing device 112 and depicts the general structure of the device 112. This fixing device 112 employs a heat roller as a fixation roller 10. The fixing device 112 in this embodiment has: the fixation roller 10 as a rotational heating member; a halogen heater 14 (which hereafter will be referred to simply as heater) as a heat source; a pressure roller 20 as a pressure applying rotational member; etc.

The fixation roller 10 has: a hollow metallic core 11; an elastic layer 12; and a surface layer 13. The metallic core 11 is made of a metallic substance, such as aluminum, iron, or the like, which is superior in thermal conductivity. The elastic layer 12 is formed of an elastic substance such as silicone rubber, and covers the virtually entirety of the peripheral surface of the metallic core 11. The surface layer 13 covers the entirety of the elastic layer. It constitutes the parting layer of the fixation roller 10. It is made of such a substance as fluorinated rubber that is relatively low in hardness. The hardness of the surface layer 13 is in a range of 20-70 (measured by Asker Durometer MD-1: product of Kobunshi Keiki Co. Ltd.). It is the surface layer 13 of the fixation roller 10 that comes into contact with the unfixed toner image on the sheet P of recording medium. This fixation roller 10 is rotatably supported by the fixing device frame (unshown) by the lengthwise ends of its metallic core 11. One of the lengthwise ends of the metallic core 11 is provided with a gear (unshown), which is rotated by a fixation motor M1 as a power source.

As the examples of the fluorinated rubber which is the soft material for the surface layer 13, binary fluorinated vinylidene rubber, tertiary fluorinated vinylidene rubber, tetrafluoroethylene-propyrene rubber, fluorophosphazene rubber, and the like may be listed. These substances can be used independently or in a blend of two or more, as the material for the surface layer 13. The laminar structure for the fixation roller 10 does not need to be limited to the above described one. That is, all that is required of the fixation roller 10 to obtain the effects of the present invention, which will be described hereafter, is that the hardness (measured by Asker Durometer MD-1) of the surface layer 13 of the fixation roller 10 is within a range of 20-70, preferably in a range of 30-50. The parting layer 13 may be made up of a single layer made of one of the fluorinated rubbers listed above, or may be made up of two or more sub-layers made up of a blend of two or more of the fluorinated rubbers listed above, as long as its hardness falls within the range of 20-70 (measured by Asker Durometer MD-1. As for the thickness of the surface layer 13, it is desired to be no less than 20 μm. The hardness of the surface layer 13 of the fixation roller 10 in this embodiment is 38.6 (Asker Durometer MD-1). The surface layer 13 in this embodiment is made of one of the fluorinated rubbers, and is 30 μm in thickness.

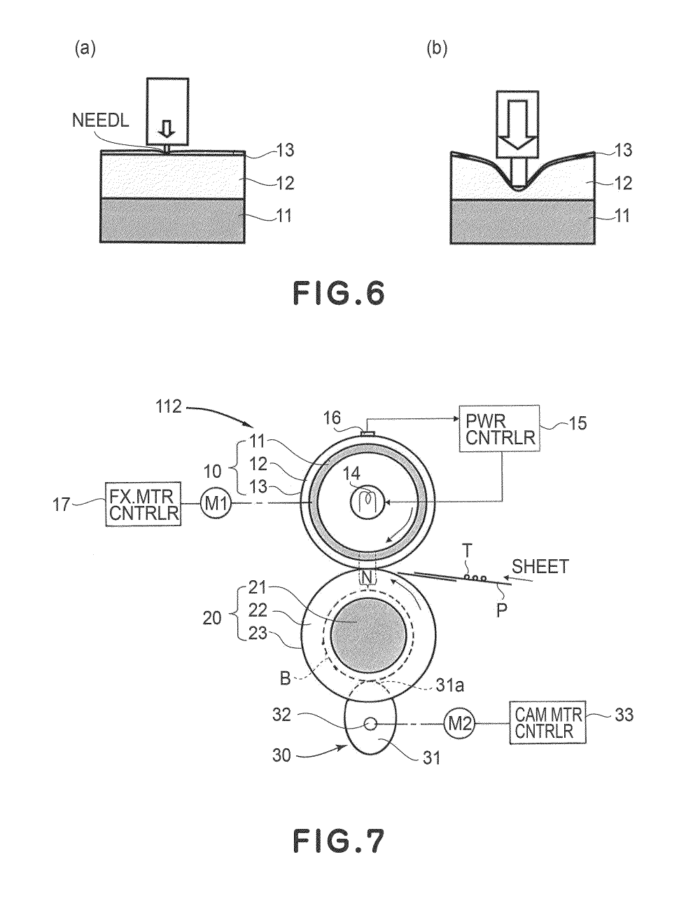

The hardness of the surface layer 13 of the fixation roller 10 was measured with the use of a Micro Durometer MD-1 Type A (product of Kobunshi Keiki C., Ltd.), which hereafter may be referred to simply as Durometer MD-1. The followings are the reasons why this durometer was used. FIGS. 6(a) and 6(b) are schematic sectional views of the surface layer 13 of the fixation roller 10 when the hardness of the surface layer 13 was being measured with the use of Durometer MD-1, and a durometer other than Durometer MD-1, respectively. The probe of Durometer MD-1, which is to be pressed upon an object to measure the hardness of the object, is very small, and does not need to compress the object very deep. Therefore, Durometer MD-1 can measure the hardness of the very surface portion of the object. In comparison, the probe of any of the durometers other than Durometer MD-1, is rather large compared to that of Durometer MD-1, and also, has to compress an object, the hardness of which is to be measured, substantially deeper. Therefore, it is likely to be affected by the layer or layers below the layer whose hardness is to be measured. For example, if the elastic layer 12 is very soft compared to the surface layer 13 as a parting layer, and the fixation roller 10 is compressed by the hardness measurement probe deep enough for the elastic layer 12 to be compressed, the value outputted by the durometer may be smaller than the hardness value of the surface layer 13, that is, the very surface layer of the fixation roller 10. Moreover, if the probe compresses the fixation roller 10 even deeper, the durometer is affected by the metallic core 11, that is, the innermost layer of the fixation roller 10. Thus, the hardness value outputted by the durometer may be substantially greater than the actual hardness of the portion of the fixation roller 11, which is in the immediate adjacencies of the surface of the fixation roller 10. The factor which greatly affects the effects of this embodiment of the present invention is the hardness of the surface layer of the fixation roller 10. This is why Durometer MD-1, which is suitable for measuring the hardness of the surface layer of the fixation roller 10, was employed to measure the hardness of the fixation roller 10. The hardness value of an object, which is obtained with the use of Durometer MD-1 type A very closely corresponds to Hardness Scale JIS-A defined in S K 6301.

The heater 14 is in the hollow of the metallic core 11 of the fixation roller 10. As electric power is supplied to the heater 14 from an electric power control portion 15, the heater 14 turns on, and generates heats, heating thereby the metallic core 11 from within the metallic core 11. The heat which the metallic core 11 received from the heater 14 conducts to the surface layer 13 through the elastic layer 12; the entirety of the fixation roller 10 is heated. The fixing device 112 is provided with a thermistor 16 as a temperature detecting means, which detects the temperature of the peripheral surface (surface layer) of the fixation roller 10. The output signals of the thermistor 16 are sent to the electric power control 15.

The pressure roller 20 has a metallic core 21, an elastic layer 22, a parting layer 23; etc. The metallic core 21 is solid, and is made of s metallic substance such as aluminum, iron, or the like. The elastic layer 22 is made up of silicone rubber or the like, and covers virtually the entirety of the peripheral surface of the metallic core 21. The parting layer 23 is made of fluorinated resin or the like, and covers the entirety of the surface of the elastic layer 22. The pressure roller 20 is under the fixation roller 10, and its peripheral surface is in contact with the peripheral surface of the fixation roller 10. It is rotatably supported by the fixation device frame, by the lengthwise end portions of its metallic roller 21, with the presence of a pair of bearings B between the lengthwise end portions of the metallic core 21 and the fixing device frame, one for one. The pair of bearings B which support the metallic core 21 by the lengthwise end portion of the metallic core 21 are supported by the fixation device frame in such a manner that the bearings B can be vertically moved.

### (Thermal Fixing Operation of Fixing Device 112)

As the control 100 receives a print start command, it outputs a drive command to the drive control 17. Then, the drive control 17 begins to rotate the fixation motor M1 in response to the drive command from the control 100. The rotation of the output shaft of the fixation motor M1 is transmitted to the metallic core 11 of the fixation roller 10 through a gear train, whereby the fixation roller 10 is rotated at the preset peripheral velocity (process speed) in the direction indicated by the arrow mark. The rotation of the fixation roller 10 is transmitted to the peripheral surface of the pressure roller 20 from the peripheral surface of the fixation roller 10, in the fixation nip N, whereby the pressure roller 20 is rotated by the rotation of the fixation roller 10. Further, the control 100 outputs a power start command to the power control 15 in response to the print start command. Then, the power control 15 begins to send electric power to the heater 14 from an AC power source (unshown) in response to the power start command, whereby the heater 14 turns on, and begins to heat the fixation roller 10 from within the metallic core 12. The power control 15 takes in the signals outputted by the thermistor 16, and controls the amount by which it sends electric power to the heater 14, in response to the signals outputted by the thermistor 16, so that the surface temperature of the fixation roller 10 remains at a preset target level (fixation temperature). While the fixation motor M1 is rotated, and the amount by which electric power is sent to the heater 14, is controlled as described above, the sheet P of recording medium, on which an unfixed toner image T is present is introduced into the fixation nip N, with the toner image bearing surface of the sheet P facing upward, and then, is conveyed through the fixation nip N while remaining pinched between the peripheral surface of the fixation roller 10 and the peripheral surface of the pressure roller 20. While the sheet P is conveyed through the fixation nip N, the toner image T on the sheet P is pressed onto the sheet P while being melted by the heat applied by the fixation roller 10. Consequently, the toner image T is thermally fixed to the surface of the sheet P. After the thermal fixation of the toner image T to the sheet P, the sheet P is discharged from the fixation nip N.

### (Mechanism 30 for Changing Fixation Nip N in Compressional Pressure)

The fixing device 112 in this embodiment is provided with a mechanism for changing the fixation nip N in compressional pressure, more specifically, a pressure changing mechanism 30 for changing the fixing device 112 in the distance between the axial line of the fixation roller 10 and the axial line of the pressure roller 20, with the use of a cam or the like. Next, referring to FIG. 7, the pressure changing mechanism 30 is described. The pressure changing mechanism 30 has a pair of cams 31, as a pressure changing means, which are in the form of an elongated disc and are on the under side of the bearings B, by which the lengthwise end portions of the metallic core 21 of the pressure roller 20 are supported, one for one. Each cam 31 is rotatably supported by the fixing device frame. More concretely, the cam 31 is attached to a cam shaft 32 which extends in the lengthwise direction of the pressure roller 20, and the cam shaft 32 is rotatably supported by the fixing device frame. The fixing device 112 is provided with a cam motor M2, as the second mechanical power source, which is for driving the gear (unshown) attached to one of the lengthwise end of the cam shaft 32. Thus, as the cam shaft 32 is rotated by the cam motor M2, the cam 31 rotated in the direction indicated by an arrow mark. The driving of the cam motor M2 is controlled by a cam motor control 33 (pressure control). The profile of the cam 31 is such that the distance between the control surface 31a, that is, the peripheral surface of the cam 31, and cam shaft 32 gradually changes. Further, the cam 31 (cam shaft 32) is positioned so that when the point of the peripheral surface 31a of the cam 31, which corresponds to the largest distance between the peripheral surface 31a and cam shaft 32, is in contact with the peripheral surface of the bearing B, the compressional pressure of the fixation nip N is highest.

The fixing device 112 in this embodiment is structured so that it can be changed in the compressional pressure of the fixation nip N by the pressure changing mechanism 30, within a range of 0.01-1 MPa. The reason why the minimum amount for the compressional pressure of the fixation nip N is set to 0.01 MPa is that it is only when the compressional pressure of the fixation nip N is no less than 0.01 MPa that the fixing device 112 is affected in the image glossiness, that is, the glossiness level at which it outputs a fixed toner image. If a user wants to change the fixing device 112 in the compressional pressure of the fixation nip N, the user is to select the desired mode among the multiple glossiness modes using the control panel (unshown) of the image forming apparatus. More specifically, in this embodiment, the image forming apparatus (fixing device 112) is provided with three glossiness modes, which are different in the amount of the compressional pressure of the fixation nip N, and which can be selected by the user with the use of the control panel. Thus, the user can set the compressional pressure of the fixation nip N to one among pressures P1, P2, and P3 which correspond to the three glossiness modes. That is, as the user selects one of the glossiness modes, the cam motor control 33 changes the attitude of the cam 31 by controlling the cam motor M2 so that one of the pressures P1, P2, and P3 is selected. More concretely, as one of the three glossiness modes is selected by the user through the control panel, the cam motor control 33 takes in the glossiness level signal which corresponds to the selected glossiness mode, from the control panel. Then, it determines the amount by which the cam motor M2 is to be rotated, in response to the glossiness mode signals. Then, it rotates the cam motor M2 by the amount it determined.

### (Control Sequence for Reversibly Changing Fixing Device in Compressional Pressure of Fixation Nip to Reversibly Change Fixing Device in Image Glossiness Level)

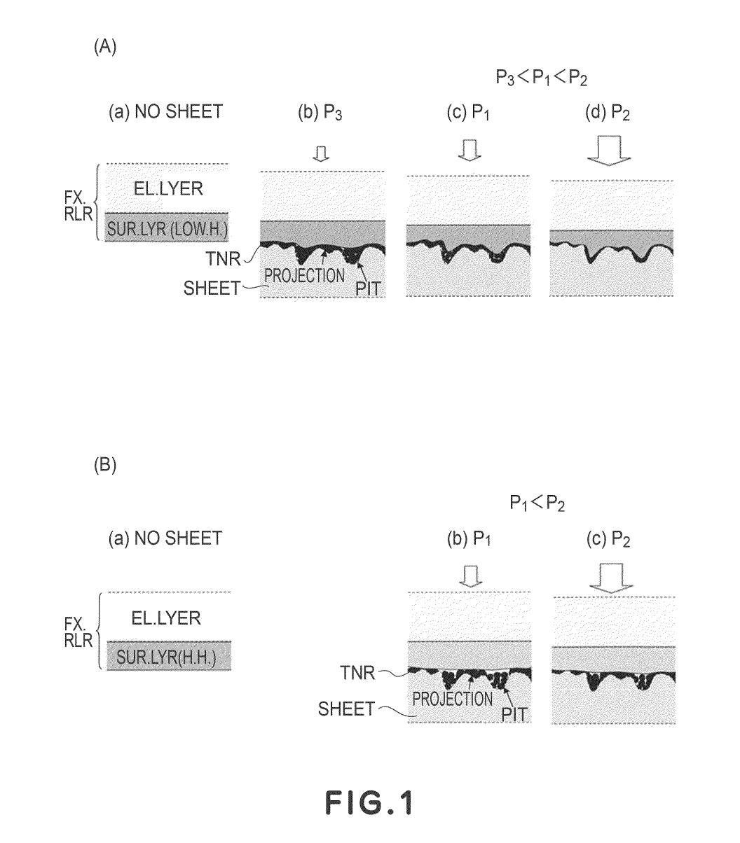

As one of the glossiness modes is selected by a user through the control panel as described above, the fixing device is reduced in the compressional pressure of the fixation nip N according to the selected glossiness mode, to raise the fixing device in the glossiness level at which it outputs an image. Next, referring to FIG. 1, the reason why decreasing the fixing device in the compressional pressure of the fixation nip N raises the fixing device in the glossiness level is described.

FIG. 1(B) is a drawing for describing how the unfixed toner image on the sheet P of recording medium is thermally fixed to the sheet P by a fixing device, such as a conventional fixing device, which employs a fixation roller, the surface layer of which is hard (surface layer is made of PFA, or the like, for example). In FIG. 1(B), (a) is a schematic sectional view of a portion of the surface layer of the fixation roller, and the portion of the elastic layer thereunder. It shows the state of the surface layer of the fixation roller. In FIG. 1(B), (b) is a schematic sectional view of the interface between the surface layer of the fixation roller and the sheet P of recording medium, in the fixation nip N. It shows the state of the surface layer, state of the sheet P of recording medium, and state of the toner (toner image) on the sheet P, when the compressional pressure of the fixation nip N was P1 (=0.2 MPa). In FIG. 1(B), (b) is a schematic sectional view of the interface between the surface layer of the fixation roller and the sheet P of recording medium, in the fixation nip N. It shows the state of the surface layer, state of the sheet P of recording medium, and state of the toner (toner image) on the sheet P, after the compressional pressure of the fixation nip N was changed to P2 (=0.3 MPa (>P1)). The target level for the surface temperature of the fixation roller was 180° C., and the fixation speed (process speed), that is, the speed at which the sheet P of recording medium was conveyed through the fixation nip N while remaining pinched by the fixation roller 10 and pressure roller 20 was 300 mm/sec.

Referring to FIG. 1(B) (b), when the fixation nip pressure was 0.2 MPa, the surface layer of the fixation roller 10 is in contact with the toner on the peaks (which hereafter may be referred to simply as peaks) of the toner image bearing surface of the sheet P of recording medium. However, the surface layer, which is relatively hard, is not compliant to the peaks and valleys (which hereafter may be referred to simply as peaks and valleys) of the toner image bearing surface of the sheet P of recording medium. Thus, it is not in contact with the body of toner in the valleys (which hereafter may be referred to simply as “valleys”) of the toner image bearing surface of the sheet P of recording medium. Since the body of toner on the peaks was melted by the heat from the fixation roller (surface layer), the toner particles in the body of toner bonded to each other, yielding a toner layer with a flat surface. On the other hand, the toner particles in the body of toner in a valley were not crushed, remaining thereby particulate. Therefore, the toner layer which they yielded was not as flat as the toner layer formed by the toner particles on a superficial peak of the sheet P of recording medium. That is, the body of toner on a peak became flat, being therefore highly glossy, whereas the body of toner in a valley remained grainy, being therefore less glossy. In other words, the resultant fixed toner image had highly glossy areas and grainy areas, and therefore, it was nonuniform in terms of glossiness. In this case, it was 8 in the glossiness level, measured at 60° with the use of a glossiness gauge VG-2000 (product of Nippon Denshoku Industries Co., Ltd.).

Next, referring to (c) of (B) of FIG. 1, since the compressional pressure of the fixation nip N was increased to P2, the body of toner on a peak of the surface of the sheet P of recording medium was flattened wider, becoming smoother in surface texture. However, the surface layer of the fixation roller 10 was not in contact the body of toner in a valley. Thus, the toner particles in the body of toner in the valley were not crushed, remaining therefore particulate. Therefore, the body of toner in a valley did not become as flat and reflective as the body of toner on a peak. Thus, the portions of the toner image, which corresponded to the peaks became flat, whereas the portion of the toner image, which corresponded to the valleys, did not become as flat as the portions of the toner image, which corresponded to the peaks. Thus, a fixed toner image outputted when the compressional pressure of the fixation nip N was P2 was higher in glossiness than a fixed toner image outputted when the compressional pressure of the fixation nip N was P1. However, it was nonuniform in glossiness. The fixed toner image outputted when the compressional pressure of the fixation nip N was P2 was 16 in glossiness level.

FIG. 1(A) is a drawing for describing how the unfixed toner image on the sheet P of recording medium was thermally fixed by a fixing device such as the fixing device 112 in this embodiment which employed a fixation roller 10, the surface layer of which was softer than the counterpart of the fixation roller of a convention fixing device. (A) of (a) of FIG. 1 is a schematic sectional view of a portion of the surface layer 13 of the fixation roller 10 when the sheet P of recording medium was yet to enter the fixation nip N. It shows the state of the outward surface of the soft surface layer 13. In (A) of FIG. 1, (c) is a schematic sectional view of the soft surface layer 13 when the compressional pressure of the fixation nip N was P1 (=0.2 MPa). It shows the state of the outward surface of the soft surface layer 13, state of the toner image bearing surface of the sheet P of recording medium, and state of the toner on the sheet P of recording medium. FIG. 1(A)(d) is a schematic sectional view of the soft surface layer 13, the toner on the sheet P of recording medium, and toner image bearing surface of the sheet P of recording medium after the compressional pressure of the fixation nip N was changed to P2 (=0.3 MPa (>P1). It shows the state of the outward surface of the soft surface layer 13, state of the toner image bearing surface of the sheet P of recording medium, and state of the toner on the sheet P of recording medium. FIG. 1(A)(b) is a schematic sectional view of the soft surface layer 13, the toner on the sheet P of recording medium, and toner image bearing surface of the sheet P of recording medium after the compressional pressure of the fixation nip N was changed to P3 (=0.3 MPa (<P1)). It shows the state of the outward surface of the soft surface layer 13, state of the toner image bearing surface of the sheet P of recording medium, and state of the toner on the sheet P of recording medium. When the soft surface layer 13, elastic layer 12, bodies of toner on the sheet P of recording medium, and sheet P of recording medium, were in states shown in FIG. 1(A)(a), 1(A)(b), 1(A)(c), and 1(A)(d), the fixing device 112 was being controlled so that the surface temperature of the fixation roller 10 remained at 180° C., and the fixation speed (process speed), that is, the speed at which the sheet P of recording medium was conveyed through the fixation nip N while remaining pinched by the fixation roller 10 and pressure roller 20, was 300 mm/sec.

Referring to (c) of (A) of FIG. 1, when the fixation nip pressure was P1, the soft surface layer 13 conformed to the peaks and valleys of the toner image bearing surface of the sheet P of recording medium; the soft surface layer 13 deformed. Thus, not only did it contact the body of toner on a peak, but also, the body of toner in a valley. In the case of the soft surface layer 13, the body of toner in a valley melted more, and therefore, the portion of the fixed toner image, which correspond to the valley of the sheet P of recording medium, was less in the size of its peaks and valleys, than in the case of the hard surface layer 13. Further, not only did the body of toner on a peak melt, but also, the body of toner in a valley melted. Therefore, the resultant fixed toner image was less nonuniform in glossiness than when the fixation nip pressure was P3. However, the soft surface layer 13 deformed by conforming to the peaks and valleys of the sheet P of recording medium. Thus, the patterns of the peaks and valleys of the deformed soft surface layer 13 were transferred onto the surface of the toner layer. Thus, even though the toner particles uniformly melted, the resultant fixed toner image was nonuniform in surface texture; its surface had minute peaks and valleys. The glossiness level was 8. Even though the variation in the hardness of the soft surface layer 13 affected the characteristics which a fixed toner image, which will be outputted by a fixing device which has the soft surface layer 13, will have. However, when the fixation nip pressure was P1, the net glossiness remained roughly the same. Thus, this fixation condition was used as the referential condition.

Next, referring to FIG. 1(A)(d), in this case, the compressional force of the fixation nip N was increased to P2 (=0.3 MPa (>P1)). Thus, the soft surface layer 13 was made to conform to the peaks and valleys of the surface of the sheet P of recording medium; it compliantly deformed. Consequently, the toner image was made to reflect more of the peaks and valleys of the surface of the sheet P of recording medium, reducing thereby in net glossiness. In this case, the glossiness level of the toner image was 4.

In the case of the soft surface layer 13 shown in FIG. 1(A) (b), the compressional force of the fixation nip N was reduced to P2 (=0.1 MPa (<P1)). Thus, the soft surface layer 13 was deformed by a proper amount. Thus, the toner layer (toner image) was made to conform in surface texture to the mildly (properly) deformed soft surface layer 13, being therefore higher in glossiness than in the case of the soft surface layer 13 shown in FIG. 1(A)(c). In this case, the glossiness level of the toner image (toner layer) was 13.

The followings are evident from the results of the experiments given above. That is, the level of glossiness at which a fixing device outputs a fixed toner image is affected by the degree of melting of toner in the fixation nip N, and the superficial texture of the fixation roller. The superficial texture of the fixation roller is affected by the hardness of the surface layer of the fixation roller and the compressional pressure of the fixation nip N, which affect the degree of conformity of the surface layer to the peaks and valleys of the surface of a sheet of recording medium. Thus, a fixing device which employs the fixation roller 10, the surface layer 13 of which is soft, can be raised in the glossiness level at which it outputs images, by reducing it in the compressional pressure of the fixation nip N, since reducing the fixing apparatus in the compressional pressure of the fixation nip N makes the surface layer of the fixation roller to conform to the peaks and valleys of the surface of the sheet P of recording medium to a proper degree. The sheet P of recording medium used in this embodiment was a sheet of ordinary paper, which was 80 g/m² in basis weight. The average dimension between the tip of a peak and the bottom of the adjacent valley of this sheet P of recording medium was roughly 10 μm, and the average distance between the adjacent two peaks (valleys) was roughly several tens of microns. As long as the surface layer of a fixation roller is formed of a substance, the hardness (measured by Asker Durometer MD-1) of which is within a range of 20-70, the surface layer can be made to conform to the surface texture of a sheet of recording medium by providing the fixation nip N with 0.01-1 MPa of compressional pressure. Further, a fixing device can be reversibly changed in image glossiness by changing the degree at which the surface layer of its fixation roller conforms to the surface texture of a sheet of recording medium, and which can be adjusted by changing the fixation nip N in the amount of compressional pressure, within a range of 0.01-1.0 MPa.

At this time, the reason why the range in which the hardness of the soft surface layer 13 of the fixation roller 10 is to be was specified to a range 20-70 is described. That is, if a substance (PFA, for example), the hardness (measured by Durometer MD-1) of which is no less than 70 is used as the material for the surface layer of the fixation roller 10, the surface layer can conform to the peaks and valleys of the surface of a sheet of recording medium only slightly, even a substance which is significantly softer than the material for the surface layer is used as the material for the intermediary layer (which corresponds to elastic layer 12 in this embodiment), which is immediately under the surface layer. Therefore, the fixation roller cannot be changed in terms of the conformity of the surface layer to the superficial peaks and valleys of a sheet of recording medium by changing the fixing device in the amount of the compressional pressure in the fixation nip N. On the other hand, if a substance (rubbery substance or the like described above) which is no higher in hardness (measured by Durometer MD-1) than 20 is used as the material for the surface layer of a fixation roller, the surface layer fully conforms to the superficial peaks and valleys of a sheet of recording medium even if the fixing device is very small in the amount of compressional pressure of its fixation nip N. Therefore, it is difficult to properly adjust the fixing apparatus in terms of the degree at which the surface layer of its fixation roller conform to the superficial peaks and valleys of a sheet of recording medium, by changing the fixing device in the amount of compressional pressure in the fixation nip N.

In a case where the hardness (measured by Durometer MD-1) of the soft surface layer 13 of the fixation roller 10 is within a range of 20-70, the thickness of the surface layer 13 is desired to be no less than 20 μm, because in order for the soft surface layer 13 to properly conform (deform) to the superficial peaks and valleys of a sheet of recording medium, in terms of the vertical distance between the tip of a peak and the bottom of the immediately adjacent valley, and also, in terms of the distance between the adjacent two peaks (valleys), when the compressional pressure of the fixation nip N is in a range of 0.01-1.0 MPa, the thickness of the soft surface layer 13 has to be in this range. There is no specific requirement regarding the hardness of the intermediary layer (which is equivalent to elastic layer 12 in this embodiment), that is, the layer which is immediately under the soft surface layer 13. That is, all that is required of the intermediate layer is that it is hard enough not to excessively deform, and hard enough to transmit the compressional pressure of the fixation nip N to the soft surface layer of the fixation roller 10, when it is subjected to the compressional pressure of the fixation nip N. Thus, the intermediary layer is desired to be no less than 20 in hardness. Incidentally, even if the intermediary layer is as hard as metal, it is possible to make a fixation roller 10 to conform to the superficial peaks and valleys of a sheet of recording medium, relying on only the deformation of the soft surface layer 13.

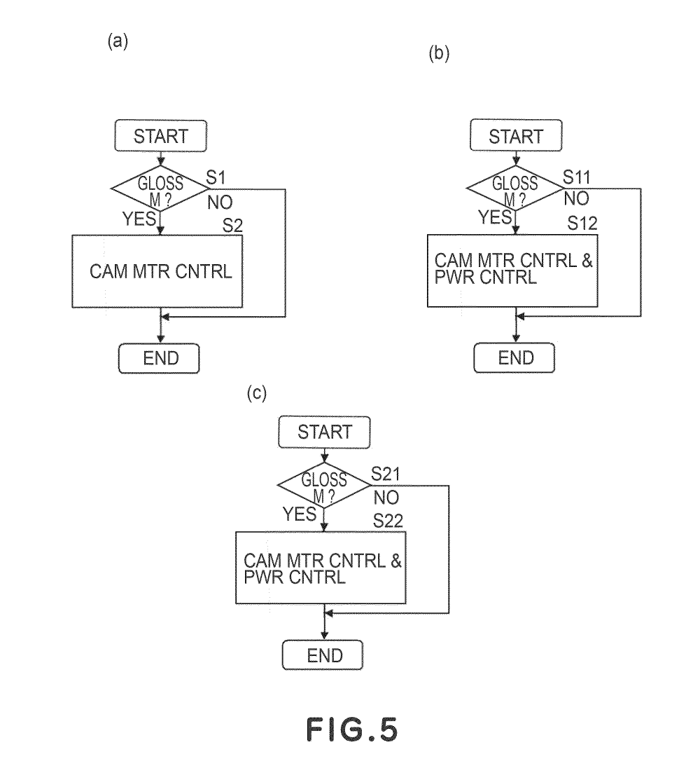

FIG. 5(a) is an example of flowchart of an operational sequence carried out by the control 100 of the image forming apparatus in this embodiment to change the apparatus in image glossiness level when the high gloss mode was selected. In S1, the control 100 determines whether or not the image forming apparatus is in the high gloss mode. If the apparatus is in the high gloss mode, the control 100 proceeds to S2. In S2, it controls the cam motor M2 with the use of the cam motor control 33. That is, the cam motor control 33 obtains the amount by which the cam motor M2 is to be rotated, in response to the glossiness mode signals (high gloss signals) which correspond to the selected glossiness mode (high gloss signals), and rotates the cam motor M2 by the obtained amount. Thus, the unfixed toner image on a sheet of recording medium is fixed in such a manner that the glossiness of the resultant fixed toner image corresponds to the selected glossiness mode.

### (Comparative Image Forming Apparatus)

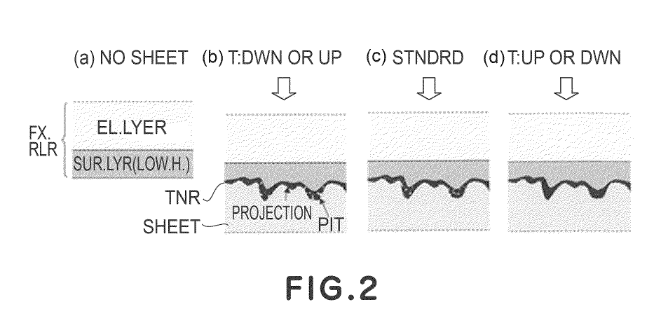

There have been known various conventional methods for changing an image forming apparatus in the glossiness level at which it outputs images (toner images). One of the conventional method is to change an image forming apparatus (fixing device) only in the temperature level at which it fixes an unfixed image, and another conventional method is to change an image forming apparatus (fixing device) only in the fixation speed. In principle, all that is necessary to raise an image forming apparatus in the glossiness level at which it outputs images is to increase the apparatus (fixing device) in fixation temperature, and/or reduce the apparatus in fixation speed. Both methods increase an image forming apparatus in the image glossiness by making the surface of a toner image flatter by melting by a greater amount, the toner of which the toner image is formed. Next, referring to FIG. 2, what occurred to the toner image (state of toner image) when the above described conventional methods for controlling an image forming apparatus in image glossiness was applied to an image forming apparatus having the above described soft surface layer 13 is described as a comparative example of a method for changing an image forming apparatus in image glossiness.

FIG. 2 is a drawing for showing the manner in which an unfixed toner image is thermally fixed by the fixing device 112 with the use of the conventional methods. FIG. 2(a) is a schematic sectional view of the portion of the soft surface layer of the fixation roller, which was in the fixation nip N, before a sheet of recording medium was introduced into the fixation nip N. It shows the state of the outward surface of the soft surface layer. FIG. 2(c) is a schematic sectional view of the portion of the soft surface layer of the fixation roller, which was in the fixation nip, when the fixing device was under the referential condition. It shows the state of the outward surface of the soft surface layer, state of the toner image bearing surface of the sheet of recording medium, and state of the toner on the sheet of recording medium. FIG. 2(b) is a schematic sectional view of the portion of the soft surface layer of the fixation roller, portion of a sheet of recording medium, and toner image on the sheet of recording medium, which were in the fixation nip when the fixation temperature was lowered, or the fixation speed was increased, in order to reduce the apparatus in image glossiness. It shows the state of the outward surface of the soft surface layer, state of the toner image bearing surface of the sheet of recording medium, and state of the toner image on the sheet of recording medium, in the fixation nip. FIG. 2(d) is a schematic sectional view of the portion of the soft surface layer of the fixation roller, portion of a sheet of recording medium, and toner image on the sheet of recording medium, which were in the fixation nip after the fixing device was increased in fixation temperature, or was reduced in fixation speed, in order to increase the image forming apparatus (fixing device) in image glossiness. It shows the state of the outward surface of the soft surface layer, state of the toner image bearing surface of the sheet of recording medium, and state of the toner image on the sheet of recording medium, in the fixation nip.

The toner particles of which an unfixed toner image is formed melt and bond with each other, forming thereby a toner layer, in the fixation nip N. Thus, if the toner particles fail to sufficiently melt, that is, if some toner particles fail to fully melt, they fail to bond with the other toner particles, remaining thereby particulate in the resultant toner layer. Thus, the resultant toner layer is not as flat across its surface as when the toner particles sufficiently melt. Therefore, the toner layer is lower in glossiness. Further, the texture of the surface of the soft surface layer is transferred onto the surface of the toner layer. In other words, the surface of the toner layer reflects the texture of the surface of the soft surface layer. The greater the amount by which toner melt, the lower the toner becomes in viscosity. Therefore, the greater the amount by which toner melt, the easier it is for the texture of the surface of the soft surface layer to transfer onto the toner layer. FIG. 2(c) represents the case in which the fixing device was reduced in fixation temperature or increased in fixation speed, compared to the case (referential case) represented by FIG. 2(c), to reduce the amount by which heat is applied to the toner per unit length of time to retard the melting of the toner. In this case, therefore, the toner particles did not bond with each other as much as they did in the referential case (FIG. 2(c)); some toner did not fully melt, remaining somewhat particulate. FIG. 2(d) represents the case in which the fixing device was increased in fixation temperature, or reduced in fixation speed, compared to the case (referential case) represented by FIG. 2(c), to increase the amount by which heat is applied to the toner per unit length of time, to promote the melting of the toner. In this case, therefore, the toner particles in the resultant toner layer was in the advanced state of bonding. Therefore, the toner layer (image) was glossier. In the case of a fixation roller, the surface layer of which is formed of a soft substance, its surface layer (soft surface layer) conforms (deforms) to the superficial peaks and valleys of a sheet of recording medium in the fixation nip N. Thus, as the toner image (toner layer) fully melt, becoming therefore free of particulate toner particles, the texture of the surface of the soft surface layer, which reflects the superficial peaks and valleys of a sheet of recording medium, is transferred onto the surface of the toner layer. Thus, the surface of the toner image somewhat reflects the superficial peaks and valleys of a sheet of recording medium, appearing less smooth than it is desired to be. In this case, therefore, the image forming apparatus (fixing device) did not increase in image glossiness. This is why changing the compressional pressure in the fixation nip is preferable as the method for changing in image glossiness, a fixing device which employs a fixation roller, the surface layer of which is formed of a soft substance. That is, as a fixing device is changed in the compressional pressure of its fixation nip, the soft surface layer of its fixation roller is changed in its conformity to the superficial peaks and valleys of a sheet of recording medium, conforming thereby to the peaks and valleys of the sheet of recording medium to a proper degree, and then, the texture of the surface layer is transferred onto the surface of the toner layer, changing the toner layer surface in texture, that is, glossiness.

The image forming apparatus in this embodiment employs the fixing device 112 which employs the fixation roller 10 having the soft surface layer 13, the hardness (measured by Durometer MD-1) of which is in a range of 20-70. Therefore, it can output toner images which are substantially less irregular in glossiness than the toner images outputted by any of image forming apparatuses in accordance with the prior art. Further, if the high gloss mode is selected to increase the glossiness level at which its fixing device thermally fix a toner image, it rotates the cam 31 to reduce the compressional pressure in the fixation nip N. Therefore, not only can the image forming apparatus in this embodiment output images which are significantly less irregular in glossiness than the images outputted by any of image forming apparatuses in accordance with the prior art, but also, it can be changed in the glossiness level at which it outputs images.

### Embodiment 2

Next, another embodiment of the present invention is described. The components, portions of components, etc., of the image forming apparatus in this embodiment, which are the same as the counterparts of the image forming apparatus in the first embodiment are given the same referential codes as those given to the counterparts, and are not going to be described. This practice applies to the description of the third preferred embodiment as well. The unique feature of the image forming apparatus in this embodiment is that the image forming apparatus in this embodiment is structures so that as the high gloss mode is selected by a user through the control panel (which hereafter may be referred to simply as “in high gloss mode”), not only is the fixing device of the apparatus reduced in the compressional pressure of its fixation nip, but also, it is increased in the temperature of the fixation roller. Otherwise, the image forming apparatus in this embodiment is the same in structure as the image forming apparatus in the first preferred embodiment. As the fixation nip N of a fixing device is reduced by a certain amount in the compressional pressure of the fixation nip N, the fixation nip N reduces in width (in terms of recording medium conveyance direction). Therefore, the length of time it takes for a sheet P of recording medium to be conveyed through the fixation nip N becomes shorter. Thus, the amount by which heat is applied to a toner image reduces. Therefore, the toner particles of which the toner image is formed fail to be fully melt; some toner particles remain particulate. That is, some toner particles fail to fully bond with others. Therefore, the surface of the resultant fixed toner image (fixed toner layer) have minute peaks and valleys. In other words, reducing the fixation nip in compressional pressure contradicts the intension to increase the image forming apparatus in the glossiness level at which the apparatus output images. In this embodiment, therefore, the effect of the change in the compressional pressure of the fixation nip N, in the high gloss mode, upon the glossiness level at which the apparatus output images is cancelled by structuring the apparatus so that even in the high gloss mode, the amount by which heat is given to the toner image while the toner image is conveyed through the fixation nip N, kept roughly the same as that in the normal mode. Here, the “normal mode” means the mode in which the unfixed toner image T is thermally fixed without changing the image forming apparatus (fixing device) in the amount of the compressional pressure of the fixation nip N.

FIG. 5(b) is an example of flowchart of an operational sequence carried out by the control 100 of the image forming apparatus in this embodiment to change the apparatus in image glossiness when the high gloss mode was selected. In S11, the control 100 determines whether or not the image forming apparatus is in the high gloss mode. If the apparatus is in the high gloss mode, the control 100 proceeds to S12. In S12, it controls the cam motor M2 with the use of the cam motor control 33. That is, the cam motor control 33 obtains the amount by which the cam motor M2 is to be rotated, in response to the glossiness mode signals (high gloss signals) which correspond to the selected glossiness mode (high gloss signals), and rotates the cam motor M2 by the obtained amount. Thus, the unfixed toner image on a sheet of recording medium is fixed in such a manner that the glossiness of the resultant fixed toner image corresponds to the selected glossiness mode. Further, in S12, the amount by which electric power is supplied to the heater 14 is controlled by an electric power control 15. That is, the electric power control 15 controls the amount by which electric power is supplied to the heater 14, so that the temperature of the fixation roller 10 remains higher, during the thermal fixation of the toner image, than in the normal mode.

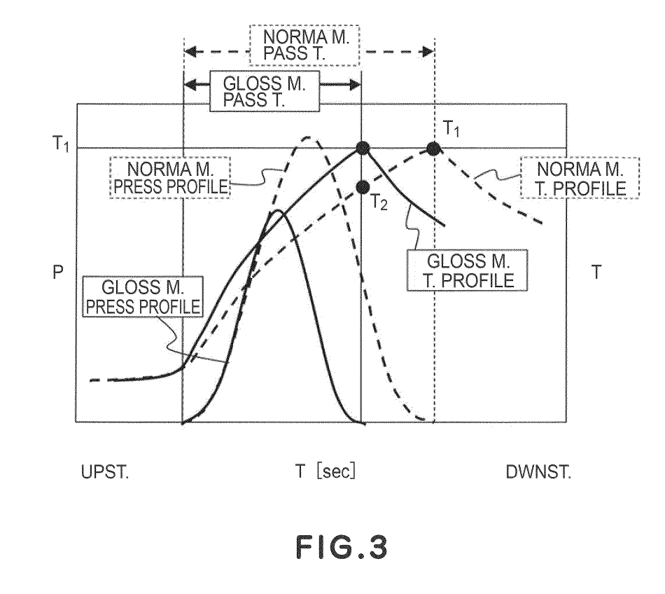

FIG. 3 is a chart which shows the compressional pressure profile and temperature profile of the fixation nip, in the normal and high gloss modes, respectively. The compressional pressure of the fixation nip N was measured with the use of a tactile sensor system PINCH (product of Nitta Co., Ltd.). The temperature of the fixation nip N was measured using the following method: A thermocouple (thermocouple of type K, which is 50 μm in line diameter: product of Adachi Instrument Co., Ltd.), which is relatively small in thermal capacity is pasted to the surface of the sheet P of recording medium, and the sheet P was conveyed through the fixation nip N of the fixing device 12 while being kept pinched between the fixation roller 10 and pressure roller 20. Then, the pressure distribution of the fixation nip N was obtained from the potential level difference signals outputted by the thermocouple, with the use of Memory Hicoder 8842 (product of Hioki Co., Ltd.).

In FIG. 3, the temperature profile and compressional pressure profile of the fixation nip N when the image forming apparatus in the normal mode are represented by broken lines, whereas those in the high gloss mode are represented by solid lines. Referring to the temperature profile in the normal mode, the nip exit temperature (temperature of fixation nip N at downstream end in terms of recording medium conveyance direction) was T1. As the fixation nip N was reduced in the compressional pressure while keeping the temperature setting the same, the fixation nip N reduced in width, and the nip exit temperature fell to T2. In this embodiment, as the high gloss mode was selected, not only was the image forming apparatus (fixing device) reduced in the compressional pressure of the fixation nip N, but also, it was increased in the temperature of the fixation roller 10. In the case of the image forming apparatus in this embodiment, if it is necessary to reduce the fixing apparatus 112 in the compressional pressure of the fixation nip N, the cam 31 is changed in attitude by controlling the rotation of the cam motor M2 by the cam motor control 33, as in the case of the image forming apparatus in the first embodiment. If it is necessary to increase the fixation roller 10 in temperature, the electric power control 15 controls the amount by which electric power is supplied to the heater 14, in such a manner that the fixation roller 10 increases in temperature compared to the fixation temperature for the normal mode. As the image forming apparatus (fixing device) is controlled as described above, the nip exit temperature increases to T1 as indicated by the temperature profile in the high gloss mode in FIG. 3, and therefore, the toner image melts roughly the same as in the normal mode.

In this embodiment, the soft surface layer 13 of the fixation roller 10 of the fixing device of the image forming apparatus was 38.6 in hardness (measured by Durometer MD-1). The normal mode was 180° C. in fixation temperature, and 0.2 MPa in compressional pressure. The high gloss mode was 190° C. in fixation temperature, and 0.1 MPa in compressional pressure. The resultant glossiness level in the normal and high gloss modes were 8 and 15 (measured by glossmeter at) 60°, respectively. There are various fixation rollers (10), which can be selected according to the process speed of the image forming apparatus. In other words, these fixation rollers (10) are different in the ideal fixation temperature. Therefore, it is desired that the fixation temperature is adjusted within a range in which the so-called hot-offset, that is, a phenomenon that the toner is excessively melted and adheres to a fixation roller, does not occur.

The image forming apparatus in this embodiment employs the fixing apparatus 112 which employs the fixation roller 10 having the soft surface layer 13, the hardness (measured by Durometer MD-1) of which is in the range of 20-70. Therefore, the images outputted by this apparatus are significantly less irregular in glossiness than those outputted by any of image forming apparatuses in accordance with the prior art. Further, if the high gloss mode is selected to raise the glossiness level at which a toner image is thermally fixed, not only does it rotate the cam 31 so that the fixation nip N is reduced in compressional pressure, but also, it controls the amount by which electric power is supplied to the heater 14, so that the fixation temperature becomes higher, during the thermal fixation of the toner image, than that in the normal mode. Thus, the image forming apparatus in this embodiment can be changed in the image glossiness, that is, the glossiness level at which it can output images, and also, can output toner images which are significantly less irregular in glossiness than those which can be outputted by any of image forming apparatuses in accordance with the prior art.

### Embodiment 3

Next, another example of the fixing device in accordance with the present invention is described. The unique features of the fixing apparatus 112 in this embodiment is that when the image forming apparatus to which it belongs is put in the high gloss mode, it reduces the compressional pressure of the fixation nip N, and also, reduces the rotational speed of its fixation roller 10 so that the length of time it takes for a sheet P of recording medium to be conveyed through the fixation nip N remains the same as in the normal mode. That is, the amount by which the length of time it takes for the sheet P to be conveyed through the fixation nip N is reduced by the reduction in the fixation nip in the high gloss mode is compensated by the reduction in the rotational speed (which hereafter may be referred to as fixation speed) of the fixation roller 10. Otherwise, the fixing device 112 in this embodiment is the same in structure as the fixing device 112 in the first preferred embodiment.

FIG. 5(c) is a flowchart of an example of operational sequence carried out by the control 100 when the image forming apparatus in this embodiment is put in the high gloss mode. In S21, the control 100 determines whether or not the image forming apparatus is in the high gloss mode. If the apparatus is in the high gloss mode, the control 100 proceeds to S22. In S22, it controls the cam motor M2 with the use of the cam motor control 33. That is, the cam motor control 33 obtains the amount by which the cam motor M2 is to be rotated, in response to the glossiness mode signals (high gloss signals) which correspond to the selected mode (high gloss signals), and rotates the cam motor M2 by the obtained amount. Thus, the unfixed toner image on a sheet of recording medium is fixed in such a manner that the glossiness of the resultant fixed toner image corresponds to the selected mode, that is, the high gloss mode. Further, in S22, the driving of the fixation motor M1 is controlled by a fixation motor control 17. More concretely, the fixation motor control 17 reduces the rotational speed of the fixation roller 10 by controlling the fixation motor M so that the length of time it takes for s sheet of recording medium to be conveyed through the fixation nip N during the thermal fixation of a toner image remains the same as in the normal mode.

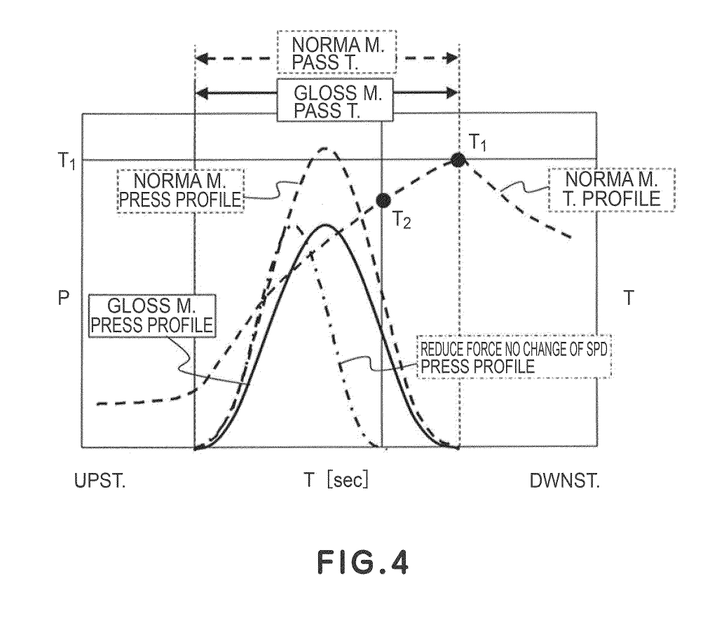

FIG. 4 is a chart which shows the compressional pressure profile and temperature profile in the fixation nip N, in the normal and high gloss modes. In FIG. 4, the temperature profile and compressional pressure profile in the fixation nip N in the normal mode are represented by two broken lines. The profile of the compressional pressure in the fixation nip N in the high gloss mode is represented by a solid line. The profile of the compressional pressure in the fixation nip N in the high gloss mode in which the fixing device was reduced in the compression pressure of the fixation nip N without being reduced in the fixation speed is represented by a single-dot chain line. Referring to the temperature profile in the normal mode, T1 stands for the nip exit temperature. As the fixing device was reduced in the compressional pressure of the fixation nip N while being kept the same in fixation speed, the nip width reduced, and therefore, it took less time for the sheet P of recording medium to be conveyed through the fixation nip N. Thus, the nip exit temperature fell to T2. In the high gloss mode in this embodiment, not only was the fixing device reduced in the compressional pressure of the fixation nip N, but also, it was reduced in fixation speed so that the length of time it takes for a sheet of recording medium to be conveyed through the fixation nip N remains the same as in the normal mode. Further, when it is necessary to reduce the fixing device 112 in the compressional pressure of the fixation nip N, the image forming apparatus in this embodiment changes the angle by which the cam 31 is rotated, by controlling the cam motor M2 with the use of the cam motor control 33, like the image forming apparatus in the first preferred embodiment. When it is necessary to reduce the fixing device in fixation speed, the fixation motor control 17 controls the fixation motor M1 so that the length of time it takes for a sheet P of recording medium to be conveyed through the fixation nip N remains the same as in the normal mode. With the fixing device controlled as described above, the nip exit temperature rose to T1 as is evident from the profile of the compressional pressure in the fixation nip N in the high gloss mode in FIG. 4. Therefore, the toner melted roughly as desirably as in the normal mode.

The image forming apparatus in this embodiment had the fixing device 112 which had the fixation roller 10 which had the fixation roller 10, the surface layer of which is lower in hardness and 38.6 in hardness (Durometer MD-1). In the normal mode, the fixation temperature, compressional pressure of the fixation nip N, and fixation speed were set to 180° C., 0.2 MPa, and 300 mm/sec, respectively. In the high gloss mode, they were set to 180° C., 0.1 MPa, and 270 mm/sec, respectively. As for the glossiness level (measure by glossimeter at 60°), it was 8 in the normal mode, and 15 in the high gloss mode.

The fixation roller 10 of the fixing device 112 employed by the image forming apparatus in this embodiment has the soft surface layer 13, that is, a surface layer, the hardness of which is in a range of 20-70 (measure by Durometer MD-1). Therefore, it is capable of outputting toner images which are significantly less irregular in glossiness than those outputted by any of image forming apparatuses in accordance with the prior art. Further, when the high gloss mode is selected to raise the glossiness level at which a toner image is to be thermally fixed, the apparatus rotates the cam 31 so that the fixing device 112 is reduced in the amount of the compressional pressure in the fixation nip N, and also, controls the fixation motor M1 so that the length of time it takes for a sheet P of recording medium to be conveyed through the fixation nip N during the thermal fixation of a toner image remains the same as in the normal mode. Thus, the image forming apparatus in this embodiment can be changed in the glossiness level at which it output images, and also, can output toner images which are significantly less irregular in glossiness than those outputted by any of image forming apparatuses in accordance with the prior art.

### Miscellaneous Embodiments

As for the type of a fixing apparatus to which the present invention is applicable, not only is the present invention applicable to a fixing apparatus of the heat roller type, but also, fixing devices of the other types than the heat roller type. That is, the present invention is applicable to a fixing device of the film heating type, a fixing device of the belt nip heating type; a fixing device of the induction heating type, and a fixing device based on a combination of two more types. Further, the present invention is also applicable to a fixing device which has two or more heating members (heat sources). Moreover, not only is the present invention applicable to a fixing device which fixes an unfixed toner image to a sheet of recording medium, but also, to a fixing device which reheats a fixed toner image to change the toner image in glossiness. Further, not only is the present invention is applicable to a fixing device which employs a fixation motor to rotate its fixation roller, but also, a fixing device structured so that the pressure roller is rotated by the “fixation motor” and the fixation roller is rotated by the rotation of the pressure roller.

While the invention has been described with reference to the structures disclosed herein, it is not confined to the details set forth, and this application is intended to cover such modifications or changes as may come within the purposes of the improvements or the scope of the following claims.

This application claims priority from Japanese Patent Application No. 147531/2010 filed Jun. 29, 2010 which is hereby incorporated by reference.

What is claimed is:

1. An image forming apparatus comprising:
an image forming station for forming a toner image on a recording material; and
a fixing portion including a heating rotatable member, a heating element for heating said heating rotatable member using heat generation by electric power supply, a pressing rotatable member for contacting said heating rotatable member to form a nip for nipping and feeding the recording material, a pressure changing member for changing a pressure to the nip, wherein said fixing portion fixes the toner image on the recording material while nipping and feeding the recording material carrying the toner image by the nip, and fixing portion is capable of changing a glossiness of the toner image by changing the pressure to the nip by operation of said pressure changing member, wherein said image forming apparatus is operable in a glossy mode in which the glossiness of the toner image is switchable,
wherein a MD-1 hardness of a surface layer of said heating rotatable member contactable with the toner image is 20-70, and when the glossy mode is selected so as to raise the glossiness at the time of heating and fixing of the toner image, said pressure changing member operates so as to lower the pressure to the nip.

2. An image forming apparatus comprising:
an image forming station for forming a toner image on a recording material;
a fixing portion including a heating rotatable member, a heating element for heating said heating rotatable member using heat generation by electric power supply, a pressing rotatable member for contacting said heating rotatable member to form a nip for nipping and feeding the recording material, a pressure changing member for changing a pressure to the nip, wherein said fixing portion fixes the toner image on the recording material while nipping and feeding the recording material carrying the toner image by the nip, and fixing portion is capable of changing a glossiness of the toner image by changing the pressure to the nip by operation of said pressure changing member, wherein said image forming apparatus is operable in a glossy mode in which the glossiness of the toner image is switchable; and
an electric power supply control portion for controlling an electric power supply amount applied to said heating element, wherein a MD-1 hardness of a surface layer of said heating rotatable member contactable with the toner image is 20-70, and when the glossy mode is selected so as to raise the glossiness at the time of heating and fixing of the toner image, said pressure changing member operates so as to lower the pressure to the nip, and said electric power supply control portion controls an electric power supply amount applied to said heating element so as to raise a target temperature of the said heating element at the time of heating and fixing of the toner image.

3. An image forming apparatus comprising:
an image forming station for forming a toner image on a recording material;
a fixing portion including a heating rotatable member, a heating element for heating said heating rotatable member using heat generation by electric power supply, a pressing rotatable member for contacting said heating rotatable member to form a nip for nipping and feeding the recording material, a pressure changing member for changing a pressure to the nip, wherein said fixing portion fixes the toner image on the recording material while nipping and feeding the recording material carrying the toner image by the nip, and fixing portion is capable of changing a glossiness of the toner image by changing the pressure to the nip by operation of said pressure changing member, wherein said image forming apparatus is operable in a glossy mode in which the glossiness of the toner image is switchable;
a driving source for rotating said heating rotatable member; and
a drive controlling portion for controlling driving of the said driving source, wherein a MD-1 hardness of a surface layer of said heating rotatable member contactable with the toner image is 20-70, and when the glossy mode is selected so as to raise the glossiness at the time of heating and fixing of the toner image, said pressure changing member operates so as to lower the pressure to the nip, and drive controlling portion controls driving of the said driving source so as to maintain nip passing time of the recording material at the time of heating and fixing of the toner image, thus lowering a rotational speed of the said heating rotatable member.
